(19) United States
(12) Patent Application Publication
(10) Pub. No.: US 2006/0223582 A1
(43) Pub. Date: Oct. 5, 2006

(54) Switching device via power key initiated wizard

(75) Inventor: Juha Simola, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/097,014

(22) Filed: Mar. 31, 2005

(51) Int. Cl. H04M 3/00

(52) U.S. Cl. 455/558

(57) ABSTRACT

A method and apparatus are provided for allowing a user to switch data containing user information from one device to another device, where the user is enabled to transfer data between devices in response to the user turning on or off the one device by either pressing a power or other suitable key on the device. In particular, the user is provided one or more options or prompts to select the manner data transfer of user information and the type of data transfer of user information to be switched from the one device to the another device. The manner of data transfer may include copying data to a SIM card, copying data to a memory card, switching data using a WLAN, switching data using Bluetooth, switching data using infrared, or some combination thereof; and the type of data transfer may include contacts, calendar, message information, other suitable personal information, or some combination thereof.

### BACKGROUND OF THE INVENTION

1. Field of Invention

The present invention related to a method and apparatus for enabling a user to switch data containing user information from one mobile terminal or device to another mobile terminal or device, including either a contact list, calendar, message information, or some combination thereof.

2. Description of Related Art

Today, mobile device or terminals have become an integral part of the normal daily lives of many people throughout the world. Some people have come to rely so heavily on mobile devices and terminals that they find it increasingly more difficult to carry out their normal daily lives without one. This is particularly true for people who travel alot, as well as people who spent alot of time on the road who need to regularly contact people or need to be reached immediately throughout the day, e.g. traveling salespeople, real estate sales people, as well as other professionals like contractors, doctors, dentists, lawyers, etc.

Because of this, users may need, have or want to have two or more mobile devices or terminals that may be used interchangeably, as well as that may be used in relation to serving different daily functions. For example, one mobile device or terminal may be carried around with the user all the time, while another mobile device or terminal may be left in their vehicle, office, home, etc. Alternatively, a user may want to have one slightly more expensive mobile device or terminal with the latest state-of-the-art functionality for sophisticated, high end, applications, while having a second slightly less expensive mobile device or terminal with less sophisticated functionality for most other routine applications, for example, to provide basic calling needs. Further, many times a user may simply misplace one mobile device or terminal and have to rely on the use of the other mobile device or terminal for some short period of time. Overall, this need or demand by users in the marketplace to have two or more mobile devices or terminals is likely to keep increasing in the future.

However, in spite of this, currently the user of two or more mobile devices or terminals faces some big obstacles in relation to managing their personal user information, including one or more contact lists, calendars, messages, etc., on the two or more mobile devices or terminals. For example, the user's contacts, calendars, messages and other related personal information may easily become scattered around, so that the user does not know whether this important information is on which SIM card, on which device memory, on which memory card, or on which mobile device or terminal. Inevitably, the contacts, calendars or messages of the different devices or terminals are likely to contain different information, etc., which is a problem to the user

In the prior art, this problem is currently solved by allowing the user of two or more mobile devices or terminals to manually copy information between the devices or terminals using either the device memory, SIM card, memory card, but this manual copy process is inherently difficult and time consuming in nature. Moreover, this copying process makes switching between the two or more devices clumsy especially for the user who constantly has to update their data e.g. by ordering business cards from company intranets and synchronizing calendar with a personal computer (PC). In practice, the user is forced to do a lot of manual work e.g. copying if they want to have their personal data left while changing from one mobile device or terminal to another mobile device or terminal. These obstacles with using multiple devices or mobile terminals lead to a situation where the user is not encouraged and/or frustrated by the use of more than one mobile device or terminal.

In summary, currently the user cannot switch or transfer data from one mobile device or terminal to another in an easy way so that all the personal information they want to use in the other device is easily copied or moved to the other device, and there is currently no true and easy support in the prior art for multiple device use or ownership despite the fact that multiple device ownership can be a very useful tool to a user. In view of this, there is a real need in the art to address and solve this problem for the user of two or more mobile devices or terminals.

### SUMMARY OF THE INVENTION

In its broadest sense, the present invention provides a method and apparatus for allowing a user to switch or transfer data containing user information from one device to another device, by enabling the user to transfer data between devices in response to turning on or off the one device by either pressing a power or other suitable key. In operation, the method may include one or more steps for asking the user one or more questions about what the user would like to do regarding the transfer of data between the devices.

In particular, the step of enabling may include providing the user one or more options or prompts to select the manner of data transfer of user information and the type of data transfer of user information to be switched from the one device to the another device. The manner of data transfer may include copying data to a SIM card, copying data to a memory card, switching data using a WLAN, switching data using Bluetooth, switching data using infrared, or some combination thereof; and the type of data transfer may include a contact list, calendar, message information, other suitable personal information, or some combination thereof.

In one embodiment, the user will receive a series of options or prompts including a prompt to select the manner of data transfer of user information. In response to a user selection in relation to the same, the user is provided a second prompt to select the type of data transfer of user information to be switched from the one device to the another device. The user may select one or more options or prompts containing information about the manner of data transfer of user information and the type of data transfer of user information to be switched from the one device to the another device. In response to the user selection of the one or more options or prompts, the user may be prompted to confirm the one or more options, and the user can be provided the optical of canceling the switching of the data by pressing a suitable soft key on the one device, including for example a soft key labeled “Cancel”. The step of enabling may also include providing the user with an audio or visual list of options or prompts for the user to switch or transfer the data between the devices.

In operation, for example, when the user presses the power button, the user is given the option “Switch device” or “Change device”. This option may be added to the current list of options (changing profile or switching of the device), as well as other suitable implementations.

One important advantage of the invention is that when the user changes the devices, the user almost always uses the power button. This means that the present invention supports the way users naturally behave while switching devices. In other words, the solution is not buried or hidden deep in menus of the user interface (UI), but instead brought very close to the user in a visible way.

Further, if the user chooses the “Change device” option, the user is then prompted through a series of steps that form part of a program, such as the known wizard program with this feature built into it, that asks the user to specify what the user wants to do while changing from one device to another.

The present invention also provides a computer program product with a program code that is stored on a machine readable carrier for carrying out the steps of the method described herein. One advantages of the present invention is that the use of multiple device ownership is made easier for the user.

### BRIEF DESCRIPTION OF THE DRAWING

The drawing, which are not to scale, includes the following Figures:

FIG. 1 is a block diagram of a first and second mobile device or terminal according to the present invention.

FIG. 2 shows a power-on option list that forms part of the present invention.

FIG. 3 shows the manner of data transfer options that forms part of the present invention.

FIG. 4 shows the type of data transfer options that forms part of the present invention.

### BEST MODE OF THE INVENTION

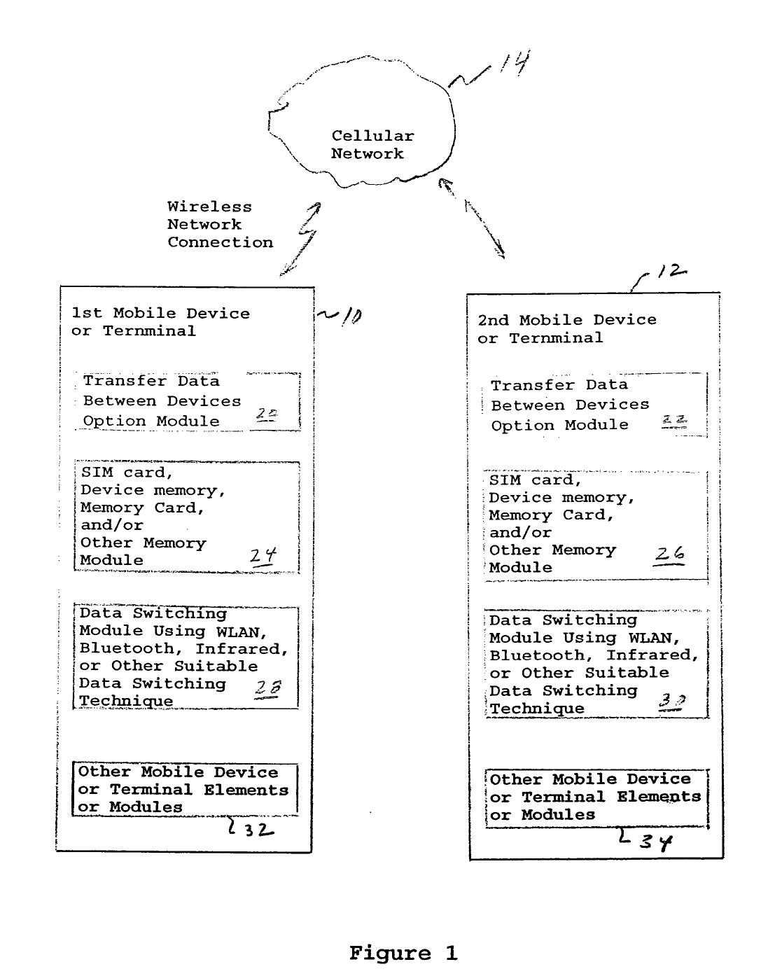

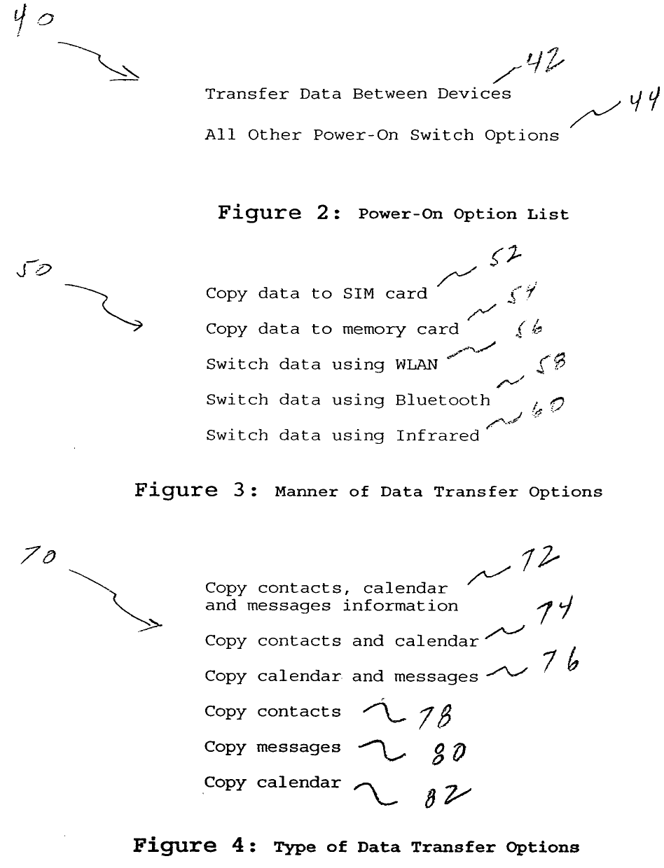

FIG. 1 shows a first and second mobile device or terminal 10, 12 coupled to a cellular network 14 via a wireless network connection. According to the present invention, each device or terminal 10, 12 enables a user to switch data containing user information to the other device. As shown, the first and second mobile device or terminal 10, 12 each include a transfer data between devices option module 20, 22; a SIM card, device memory, memory card, and/or other memory module 24, 26; a data switching module using WLAN, Bluetooth, infrared, or other suitable data switching technique 28, 30; and other mobile device and terminal modules 32, 34. The first and second mobile device or terminal 10, 12 is uniquely characterized by the transfer data between devices option module 20, 22, that provides the user with a list generally indicated as 40 in FIG. 2 having a transfer data between devices option or prompt 42 displayed for the user in response to the user turning on or off the device or terminal 10, 12 either by pressing the power or other suitable key of the device or terminal 10, 12. In operation, the module 20, 22 may provide one or more prompts for asking the user one or more questions about what the user would like to do regarding the transfer of data between the devices consistent with that described below. (In FIG. 2, the list 40 also has a prompt or option 44 for “all other power-on options” which includes other options that user may select after powering-on the device which are known in the art and do not form part of the present invention.)

FIGS. 3 and 4 show the one or more manners or types of data transfer options that may appear after the user selects the transfer data between devices option 42 in FIG. 2, including one or more options or prompts to select the manner of data transfer for switching user information from the one device to the another device as shown in FIG. 3 and/or the type of data transfer of user information to be switched from the one device to the another device as shown in FIG. 4.

In FIG. 3, the manner of data transfer is generally indicated as 50 and includes options or prompts 52, 54, 56, 57, 60, respectively, for copying data to a SIM card, copying data to a memory card, switching data using a WLAN, switching data using Bluetooth, switching data using infrared, or some combination thereof. The scope of the invention is not intended to be limited to the manner of data transfer for switching user information from the one device or terminal to the other device or terminal. For example, the scope of the invention is intended to include manners of data transfer both now known in the art, as well as those later developed in the future.

In FIG. 4, the type of data transfer of user information is generally indicated as 70 and includes options or prompts 72, 74, 76, 78, 80, 82 for contacts, calendar, message information, other suitable personal information, or some combination thereof. The scope of the invention is not intended to be limited to the type of data transfer of user information switched from the one device or terminal to the other device or terminal. For example, the scope of the invention is intended to include types of data transfer both now known in the art, as well as those later developed in the future.

### The Basic Operation

By way of example, the following sets forth one basic example of the operation of the present invention:

1. The user presses the power button of the device or terminal.

2. The user chooses the “Switch device” option 42 shown in FIG. 2 and presses the “Select” soft key on the device or terminal keypad.

3. The user is given one or more of the data transfer options 50 shown in FIG. 3 depending on the user device and connectivity technology, e.g.:
a. Copy data to SIM card,
b. Copy data to memory card,
c. Switch data using WLAN,
d. Switch data using Bluetooth, or
e. Switch data using Infrared.
   In response, the user may select, for example, the option 52—copy data to SIM card.

4. The user is then given one or more of the following data options 70 shown in FIG. 4:
a. Copy contacts, calendar and messages information,
b. Copy contacts and calendar,
c. Copy calendar and messages,
d. Copy contacts,
e. Copy messages, or
f. Copy calendar.
   In response, the user may select, for example, the option 78—copy contacts.

5. The user may be asked for a confirmation with, for example, the prompt: “Do you want to copy all your contacts to your SIM card?” In response, the user may select “OK” from a soft key on the keyboard.

6. In response, all contacts from memory card and device memory are copied to the user's SIM card. The user may also be shown the following information notes: “Copying all contacts to SIM card” or “Copied all contacts to SIM card” to keep the user informed about the status of the copying process.

7. After copying, the device or terminal 10, 12 may be switched off by the user.

8. The user may then take the SIM card out of the one device and insert it to the other device. When the other device is switched on, the user is again prompted as to whether the user wants to copy the contacts from the SIM card to the device memory for storing the data on the other device.

The user can terminate the process at any point by choosing, for example, “Cancel” on the right soft key or by pressing the red telephone button.

The Transfer Data Between Devices Option Module 20, 22

The functionality of the transfer data between devices option modules 20 and 22 shown in FIG. 1 may be implemented using hardware, software, firmware, or a combination thereof. In a typical software implementation, the modules 20 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the transfer data between devices option module 20 and 22 being a stand alone module in the device or terminal, or forming part of another module in the device or terminal, including the module for running the Wizard or other suitable program in devices or terminal now known in the art.

### Modules 24, 26

The SIM card, device memory, memory card, and/or other memory modules 24, 26 are known in the art, and the scope of the invention is not intended to be limited to any particular type or kind thereof. The scope of the invention is intended to include using the basic invention together with other SIM card, device memory, memory card, and/or other memory modules now known or later developed in the future.

### Modules 28, 30

The data switching module using WLAN, Bluetooth, infrared, or other suitable data switching technique 28, 30 are known in the art, and the scope of the invention is not intended to be limited to any particular type or kind thereof. The scope of the invention is intended to include using the basic invention together with other data switching module using WLAN, Bluetooth, infrared, or other suitable data switching technique now known or later developed in the future.

### Other Mobile Terminal or Device Elements or Modules 22, 24

The devices or terminals 10, 12 respectively may also include other mobile terminal or device elements or modules 32, 34 that are known in the art, including a keyboard having one or more keys or control buttons; keyboard control module; an audio accessory (e.g. headphone or ear plug); an audio accessory control module; wireless connection protocol module (including a BT SAP connection module); flip, cover or slide mechanism(s); flip, cover or slide mechanism control module(s); module parts or attachments (including conference stand, docking station, etc.); modular parts or attachments control module; a display; a display control module; a keyboard module; and antenna module; a memory module in addition to that discussed above; input/output modules; a processor or control module; etc.

The First and Second Mobile Device or Terminal 10 and 12

The first and second device 10 and 12 may include a mobile phone, user equipment, mobile terminal, a PDA, a communicator, which are all known in the art, but may include other types or kinds of devices now known or later developed in the future. The scope of the invention is not intended to be limited to any particular type or kind of device or terminal. Moreover, the scope of the invention is not intended to be limited to any particular type or kind of cellular network or wireless network connection for coupling the same to these devices or terminals.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method for allowing a user to switch data containing user information from one device to another device, characterized in that
the method includes the step of enabling the user to transfer data between devices in response to the user turning on or off the one device by either pressing a power or other suitable key.

2. A method according to claim 1, wherein the step of enabling includes providing the user one or more options or prompts to select the manner of data transfer of user information and the type of data transfer of user information to be switched from the one device to the another device.

3. A method according to claim 2, wherein the manner of data transfer includes copying data to a SIM card, copying data to a memory card, switching data using a WLAN, switching data using Bluetooth, switching data using infrared, or some combination thereof.

4. A method according to claim 2, wherein the type of data transfer includes contacts, calendar, message information, other suitable personal information, or some combination thereof.

5. A method according to claim 4, wherein the manner of data transfer includes copying data to a SIM card, copying data to a memory card, switching data using a WLAN, switching data using Bluetooth, switching data using infrared, or some combination thereof.

6. A method according to claim 2, wherein the one or more prompts include a first prompt to select the manner of data transfer of user information.

7. A method according to claim 6, wherein, in response to a user selection in relation to the first prompt, the user is provided a second prompt to select the type of data transfer of user information to be switched from the one device to the another device.

8. A method according to claim 1, wherein the user selects one or more options or prompts containing information about the manner of data transfer of user information and the type of data transfer of user information to be switched from the one device to the another device.

9. A method according to claim 8, wherein, in response to the user selection of the one or more options or prompts, the user is prompted to confirm the one or more options.

10. A method according to claim 1, wherein the method includes switching the data from the one device to the another device.

11. A method according to claim 10, wherein the method includes providing user with a confirmation that the data was switched from the one device to the another device.

12. A method according to claim 1, wherein the method includes the step of enabling includes providing the user with an audio or visual list having options for the user to transfer the data between devices.

13. A device for allowing a user to switch data containing user information to another device, characterized in that the device includes a module for enabling the user to transfer data between devices in response to the user turning on or off the one device by either pressing a power or other suitable key.

14. A device according to claim 13, wherein the module provides the user with one or more prompts to select the manner of data transfer of user information and the type of data transfer of user information to be switched from the one device to the another device.

15. A device according to claim 14, wherein the manner of data transfer includes copying data to a SIM card, copying data to a memory card, switching data using a WLAN, switching data using Bluetooth, switching data using infrared, or some combination thereof.

16. A device according to claim 14, wherein the type of data transfer includes contacts, calendar, message information, other suitable personal information, or some combination thereof.

17. A device according to claim 16, wherein the manner of data transfer includes copying data to a SIM card, copying data to a memory card, switching data using a WLAN, switching data using Bluetooth, switching data using infrared, or some combination thereof.

18. A device according to claim 14, wherein the one or more prompts include a first prompt to select the manner of data transfer of user information.

19. A device according to claim 18, wherein, in response to a user selection in relation to the first prompt, the user is provided a second prompt to select the type of data transfer of user information to be switched from the one device to the another device.

20. A device according to claim 13, wherein the user selects one or more prompts containing information about the manner of data transfer of user information and the type of user information to be switched from the one device to the another device.

21. A device according to claim 20, wherein, in response to the user selection of the one or more options or prompts, the user is prompted to confirm the one or more options.

22. A device according to claim 13, wherein the module initiates the switching of the data from the device to the another device.

23. A device according to claim 22, wherein the module provides the user with a confirmation that the data was switched from the one device to the another device.

24. A device according to claim 13, wherein the module provides the user with an audio or visual list having options for the user to transfer the data between devices.

25. A method according to claim 1, wherein the method further comprises implementing the step of the method via a computer program running in a processor or controller in a device.

26. A computer program product with a program code, which program code is stored on a machine readable carrier, for carrying out steps of a method for enabling the user to transfer data between devices in response to the user turning on or off the one device by either pressing a power or other suitable key, when a computer program is run in a processor or control module of the device.

27. A method according to claim 1, wherein the method includes one or more steps for asking the user one or more questions about what the user would like to do regarding the transfer of data between the devices.

28. A device according to claim 13, wherein the module provides one or more prompts for asking the user one or more questions about what the user would like to do regarding the transfer of data between the devices.
